(19) United States
(12) Patent Application Publication
(10) Pub. No.: US 2012/0227567 A1
(43) Pub. Date: Sep. 13, 2012

(54) Translucent Instrument Bell with Lighting System

(75) Inventors: Glenn Barberot, Metairie, LA (US); Kevin M. Jones, Tomball, TX (US)

(73) Assignee: Kevin M. Jones, Tomball, TX (US)

(21) Appl. No.: 13/046,026

(22) Filed: Mar. 11, 2011

(51) Int. Cl. G10D 7/10

(52) U.S. Cl. 84/387 R

(57) ABSTRACT

A musical instrument with a translucent or transparent bell of clear or colored composition having light emitting elements positioned such as to transmit light throughout the bell of the instrument, the lights being capable control for sequential flashing display of intensity and/or color, controlled either by electronic sequential timing or in response to the sound or vibrations produced by the instrument.

### BACKGROUND OF THE INVENTION

The tuba is arguably the most eye catching instrument of a marching band. With the large circle of a sousaphone bell floating over the musician's head, it is hard to miss the tuba section even from the highest and farthest seats in the stadium. While the marching band is still a block or more away, the drum line maybe the first thing heard by the crowd of spectators lining the streets to see a parade, but the Sousaphones are the first instruments spotted due to their bell's prominent position high in the air above the musicians.

Musicians, especially those of marching bands, need to be both visually and audibly entertaining to the crowd. Horn players contribute to the visual aspect of their performance by using a move called the ‘horn flash’. By changing the angle of the instrument, the musician can pan a reflection of light across a crowd. To a spectator it may appear as if the player just flashed a light. This move has been expanded to the level where all the musicians, depending on their instrument, will perform a predetermined choreographed movement thus animating the entire instrument section, and maybe the entire band.

Another visual effect usually limited to the tuba section is the use of bell socks. Bell socks are tight fitting cloth covers which are often silk-screened or printed in other manners with emblems or logos representing the group. In some larger bands letters are used to spell out the name of the school or organization. Some musicians even paint directly onto the tuba's bell.

All of the above work well for visual effects if the musician is performing in the day light, on a lighted stage, or under stadium lights. However, the effects will have minimal effect when the musician is performing in a darkened area, such as a night parade such as those often found in New Orleans during the Mardi Gras season.

Previous attempts have been made to light up instruments such has Juan Novo's patent granted Aug. 11, 1987 which discussed a flute which was formed from a light transmitting material with an illumination means mounted in the crown portion, or the recorder patented by Edward Sueta, et al., issued Aug. 2, 2005 with a body fabricated from a clear or translucent light-transmitting material. These instruments have some particular draw backs. Most translucent light-transmitting material has a poor tonal quality. Thus plastic instruments sound plastic. They do not have the rich tonal qualities of a brass or wood instruments and therefore are rejected by most serious players as toys. Instrument makers and players realize that it is far more than the look of an instrument that contributes to the performance. The instrument must have a rich pleasing tonal quality before cosmetic changes can be tolerated.

The sousaphone is a unique instrument in that, although used in many situations, it is made especially for marching bands. Because of its unique shape and design to encircle the body of the musician and position the bell up above the head of the musician, the tuba is often manufactured in sections which are easily separated for transport. The main body of the instrument is usually separable from the bell.

### BRIEF DESCRIPTION OF THE DRAWINGS

FIG. 1A illustrates a front view of a musician with a musical instrument having a translucent bell in accordance with an exemplary embodiment of the invention.

FIG. 1B illustrates a side view of a musician with a musical instrument having a translucent bell in accordance with an exemplary embodiment of the invention.

FIG. 2A illustrates a front view of a translucent bell of a musical instrument in accordance with an exemplary embodiment of the invention.

FIG. 2B illustrates a side view of a translucent bell of a musical instrument in accordance with an exemplary embodiment of the invention.

FIG. 3A illustrates a musical instrument with artwork silhouetted into the bell in accordance with an exemplary embodiment of the invention.

FIG. 3B illustrates a plurality of musical instruments with screened bell socks in accordance with an exemplary embodiment of the invention.

FIG. 4A illustrates a front view of a translucent bell of a musical instrument with an odd number of opaque divisors in accordance with an exemplary embodiment of the invention.

FIG. 4B illustrates a front view of a translucent bell of a musical instrument with an even number of opaque divisors in accordance with an exemplary embodiment of the invention.

FIG. 5 illustrates a sequence of lighting patterns for use by a translucent bell of a musical instrument with an odd number of opaque divisors in accordance with an exemplary embodiment of the invention.

FIG. 6 illustrates a sequence of lighting patterns for use by a translucent bell of a musical instrument with an even number of opaque divisors in accordance with an exemplary embodiment of the invention.

FIG. 7 illustrates a translucent bell of a musical instrument with chemical lighting elements in accordance with an exemplary embodiment of the invention.

FIG. 8A illustrates a translucent bell of a musical instrument with electronic elements in accordance with an exemplary embodiment of the invention.

FIG. 8B illustrates an adapter collar for use with a translucent bell of a musical instrument in accordance with an exemplary embodiment of the invention.

### DETAILED DESCRIPTION OF THE PREFERRED EMBODIMENTS

The tuba is the largest member of the brass instrument family. As with all brass instruments, the sound is produced by buzzing the lips into a mouthpiece. That vibrating air is shaped by the tubular body of the instrument which is varied in length by rerouting through ancillary tubing with valves or pistons, and finally directed out through the bell. The sousaphone, often called a marching tuba, is a unique instrument in that it was designed especially for marching bands. Because of its unique shape and design to encircle the body of the musician and position the bell up above the head of the musician, the tuba is often manufactured in sections which are easily separated for transport and storage. Most sousaphones are manufactured from sheet brass with silver or gold plating, or a lacquer finish. However some are made from reinforced fiberglass resulting in a significant weight reduction, which is often necessary for the instrument to be manageable for smaller musicians, e.g. young players. More serious players refer to these as white trash or Tupperware tubas due to their inferior tonal qualities. Whether made from brass or fiberglass, the main body of the instrument is usually separable from the bell. While most concert tubas do not have detachable bells, some tubas, especially those with front facing bells may be separable. The term tuba and sousaphone is used interchangeably throughout the rest of this discussion.

With the BBb tuba being comprised of approximately 18 feet of tubing, and the bell being only a foot to a foot and a half of that length, the bell is less than 10% of the total instrument length. Being less than 10% of the total instrument length, the bell may be made of a different material from that used in the body with only minimal impact to the tonal qualities of the instrument. Further, any effect on tonal qualities can be minimized with varying thicknesses and reinforcement through ribbing of the instrument's bell.

When a sousaphone is played in the stands at a sports event, the unfortunate fans seated behind the tuba(s) have an obstructed view of the play arena. By manufacturing the tuba's bell from a clear transparent material such as an acrylic or plastic material, the bell is no longer opaque. Thus, the bell is less of a hindrance to spectators who can, at least, follow the action from one side of the field to the other with minimal distortion or obstruction of their view. The curve of the bell, even when manufactured from a purely transparent material, will still yield a distortion to the view. So, while sitting behind a transparent tuba bell may not be like watching the movement through a window, it is certainly less like watching through a solid wall.

A bell manufactured from a transparent or translucent material can be tinted with different colors. In one embodiment, a combination of colors can be used to obtain different shades or a mixing of colors in patterns or swirls which are decorative and add to the visual effect. A single player could have two colors intermixing. An example would be a tuba player from the “Golden Band from Tigerland” having a bell with a swirled pattern made up of the purple and gold of the LSU Tigers from Baton Rouge, Louisiana. A plurality of single color bells could be intermixed within the instrument section. As an example, the Gator Marching Band of the University of Florida could have alternating tubas with blue and orange bells. In another example a single colored bell could be used for emphasis. As an example, it is traditional, when the Ohio State University Marching Band performs the script Ohio formation, that a fourth- or fifth- year sousaphone player is given the privilege of dotting the “i.” That one sousaphone player could swap their regular sliver bell with a scarlet one just before going on the field to dot the ‘i’ thus adding an additional emphasis on the position.

Various glassy thermoplastics or resins and fibers can be used to create semi-transparent material with or without tinting. These acrylic like materials can transmit light through internal reflections. By coating an acrylic structure or applying various finishes, the reflective properties can be manipulated to allow more or less of the internal light to be reflected back in to the material, thus allowing the rest to escape from the surface and causing a luminescent affect. A bell constructed of an acrylic like material with a light source at one or more points would then transmit that light through internal reflection to all points of the construction. By coating different parts of the bell, such as the insides of the tube and the back of the bell, the luminescent effect can be directed in the same direction as the sound. Further, by creating clouded or opaque channels or points in the bell's material the light can be further directed or affected to produce interesting visual effects.

In one embodiment, a series of Light Emitting Diodes (LEDs), which may be Laser diodes or high intensity diodes, are positioned around the portion of the bell near where it connects to the main body. The lower end of the bell is then finished such that most of this light is reflected upwards toward the outer rim of the bell, which is polished to allow the light to escape. As the light is transmitted through the bell material it is disbursed evenly throughout the material so that the individual light sources are indistinguishable and instead a continuous glow is produced across the rim of the bell. In such a scenario the LEDs may be of different colors such that the final light emanating from the bell is a mixture of the colors into a single composite color. Thus by positioning reddish and bluish LEDs near the base of the bell, a purplish glow would be produced at the rim of the instrument; and by positioning yellowish and reddish LEDs near the base of the bell, a goldish color would be visible at the rim.

In another embodiment a series of opaque channels are cast into the bell so that the bell is divided into multiple different lighting compartments. In the first preferred embodiment this would be an even number of channels. In this embodiment all three color LEDs would be position in each compartment so that by alternating the colored LEDs turned on in each compartment, the colors in the bell's rim could alternate between both purple and gold. In the second preferred embodiment an odd number of channels are used and the LEDs in a series of 3 channels are alternated between the following states On-Off-Dim; Dim-On-Off, Off-Dim-On. When one or more groups of three channels are illuminated in this pattern the effect is a chasing light pattern. In this embodiment, the On, Dim and Off states could be replaced with three distinct colors thus producing a chasing colors pattern.

Light can be produced from a chemical source such as the combination of hydrogen peroxide and phenyl oxalate ester in the presence of a florescent dye. This is the type of chemical reaction referred to at chemiluminescence and is commonly found in lightsticks or glow sticks. In one embodiment one or more of these chemical lighting stick can be attached to the bell such that their light is transmitted into the bell material. On method of doing this would be to place the chemiluminescent device against a polished portion of the bell and covering it with an opaque material, which is preferably reflective. This causes the light to be transmitted into and through the bell material so that it comes from the rim of the bell.

In one embodiment the entire front face of the bell is polished such that the entire bell glows. In another embodiment a portion of the front face is polished so that only that portion glows. In one embodiment, the portion of the front face that is polished can be configured into designs, words, or logos which will then illuminate with the light escaping from the bell material. In another embodiment the reverse process is used such that portions of the bell are masked or coated to be opaque thus creating a shadow type of effect.

Different tuba manufacturers make the bell separable from the main body in different areas such that at the point of separation may result in different diameter's of tubing at the separation points. By use of an adapter collar with different sized mating diameters on the main body side of the collar, it would be possible for a single sized transparent bell to be used with instruments from different manufacturers. If the sizes are close enough, a single collar could be used with stepped seats for connecting to the main body allowing a single collar to be used for multiple instrument manufacturers.

Turning now to the drawings, one skilled in the art will appreciate the discussions as being illustrative of the general concept developed by the inventors and will realize the multitude of different options available for implementation in different embodiments. The descriptions included in this specification should be taken as such and not considered limited to the exact embodiments described.

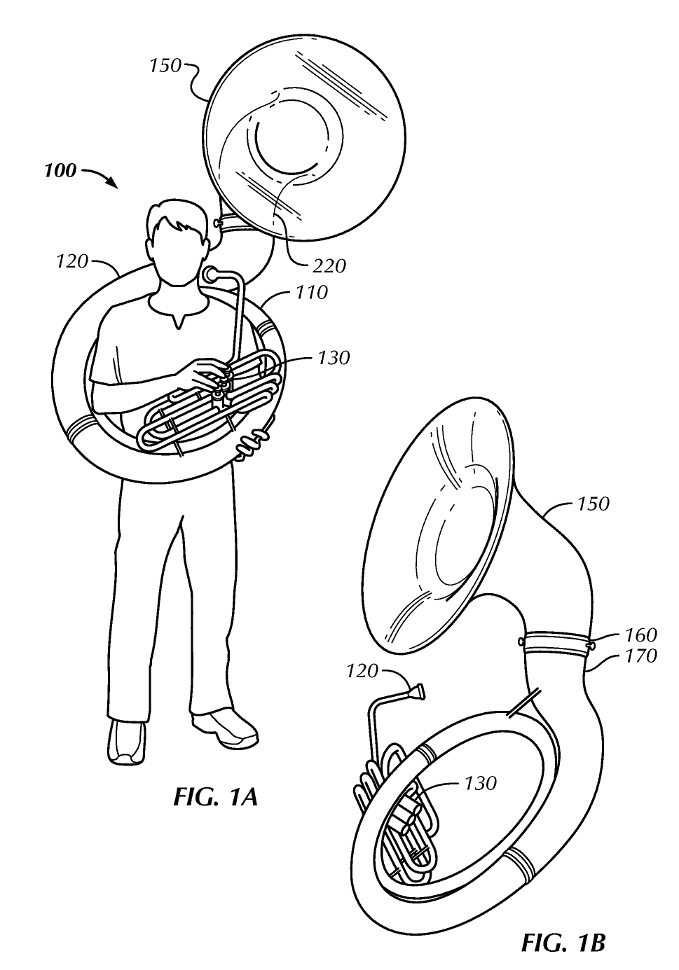

Referring to FIGS. 1A and 1B illustrate a musical instrument (100) having a translucent bell (150) in accordance with an exemplary embodiment of the invention. In the particular embodiment illustrated, the musical instrument is what is commonly referred to as a sousaphone, or a marching tuba. The sousaphone player or musician (140) stands with the musical instrument (100) around his/her body with most of the weight resting on the left shoulder. In this position, the mouthpiece (120) is positioned in front of the lips, and the lead pipe joins to the valves and alternate tubular assembly (130) at the lower end of the main body (110) which joins with the bell (150) at the opposite end of the main body (170). A collar (160) or a joint fastens the bell (150). In most configurations on the market, the bell (150) is removably fastened to the main body (110) by a collar (160) which is often permanently attached to the end of the main body (170). Thumbscrews (810) or some other removable method is used to allow the bell (150) to be removed for storage and transport, or possibly for replacement with a new bell constructed in accordance with an embodiment of the current invention.

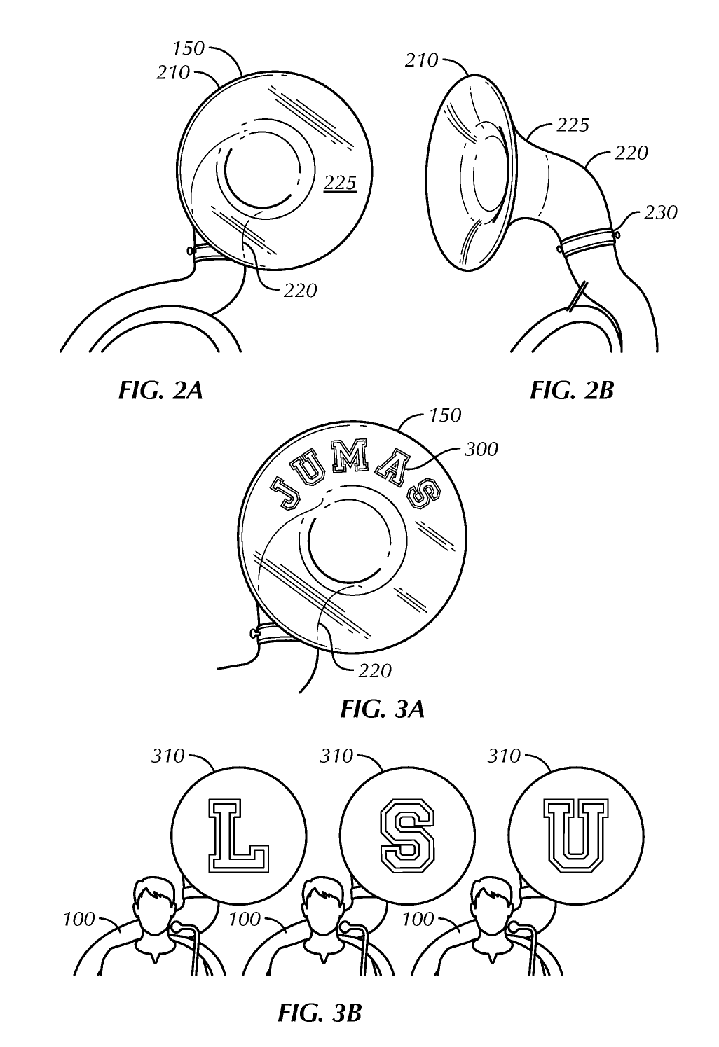

FIGS. 2A and 2B illustrate a front and side view of a translucent bell (150). Clearly visible are the components which comprise the bell starting with the base of the bell (230) where the tubular shape is near its smallest diameter, and continuing through the tapered portion of the bell (220) to the flaired portion of the bell (225) and ending at the rim (210). In a conventional musical instrument made of brass, this rim is constructed by rolling the sheet material comprising the flaired portion (225) around a steel wire to reinforce the rim (210) of the bell. In one embodiment of the invention, the rim is constructed of a built up material of a greater thickness which is polished to create a semi-cylindrical lens which rings the edge of the bell and works like a prism or magnifier to disburse light transmitted through the material.

In one embodiment, the entire bell is transparent to allow spectators seated behind the instrument to see thorough the instrument's bell (150). In another embodiment only the flaired portion (225) of the bell is transparent. In another embodiment, the tapered portion (220) of the bell is finished such that the surface has an internal reflectivity causing it to channel light along the material. In this embodiment, the external surface of the instrument could be smooth, rough, semi-transparent, or opaque. The non-transparent surface could have an additional coating. This additional coating could serve as a protection to the surface or be decorative.

In one embodiment the front and rear of the flaired portion (225) can be finished in a manner similar to that described in the preceding paragraph. In another embodiment, both the front and rear of the flaired portion (225) are finished such that they allow light transmitted through the material to exit the surface only at the rim (210). In another embodiment, only one surface is finished in such a manner such, and the other surface is polished such that light transmitted through the material exits across the entire polished surface.

FIG. 3A illustrates an embodiment where a polished front side of the flaired portion (225) is embellished with artwork (300) which is at least semi-opaque causing it to be silhouetted by the light emitted from the polished surface. In another embodiment, the effect previously described is reversed such that only the art work emits light and the rest of the bell is internally reflective.

FIG. 3B illustrates a plurality of musicians (100) carrying musical instruments with screened bell socks (310). These semi-transparent coverings are adhered to the front face of the flaired porition (225) of the bell. Any artwork (300) on the bell sock (310) is then silhouetted by light emitted from the bell (150). In another embodiment, the effect previously described is reversed such that only the art work emits light and the rest of the bell sock is opaque or internally reflective.

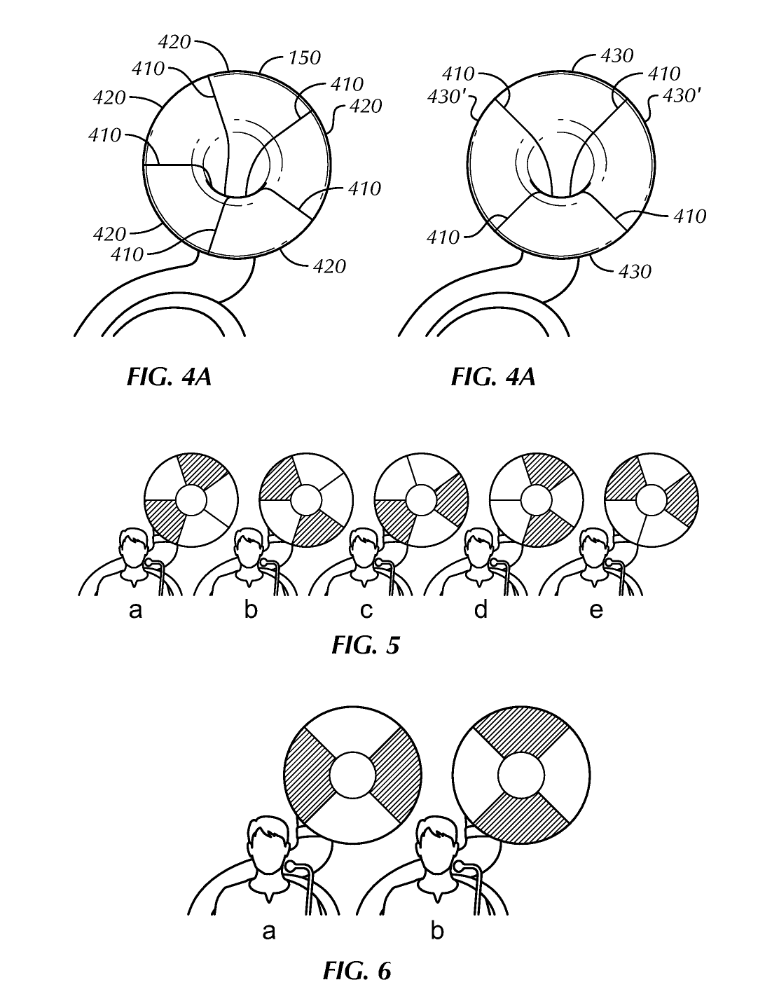

FIGS. 4A and 4B illustrates a front view of a translucent bell (150) of a musical instrument (100) with opaque divisors (410) which form channels (420) through which light can be transmitted. In such a configuration, there can be an odd number of opaque divisors (410) and channels (420) as illustrate in FIG. 4A, or there can be an even number of opaque divisors (410) and channels (420) as illustrate in FIG. 4B. In one embodiment these divisors extend from the base of the bell (230) to the rim of the bell (210) such that separate channels are created. In such an configuration, different lights of varying intensity, color and state can be controlled to create interesting affects. FIG. 5 illustrates a pattern that can be used in an embodiment with an odd number of channels such that when the patterns are cyclically repeated the affect is that of a spinning wheel or chasing light effect. FIG. 6 illustrates a pattern that can be used in an embodiment with an even number of channels such that when the patterns are cyclically repeated the affect is an alternating positional pattern. In one embodiment the patterns are created by turning on and off lights. In another embodiment the patterns are created by varying the intensity of lights. In another embodiment the patterns are created by changing the colors of the lights. In another embodiment a combination of the affect are used. In one embodiment, one or more adjacent channels are controlled as a single channel thus allowing grouping of the channels to produce any of the desired affects described above. In one embodiment the intensity of the lights can be controlled such that the further away from the light source, the lower the intensity creating a fading effect along the channel This affect is particularly effective in a helical channel configuration (not illustrated.)

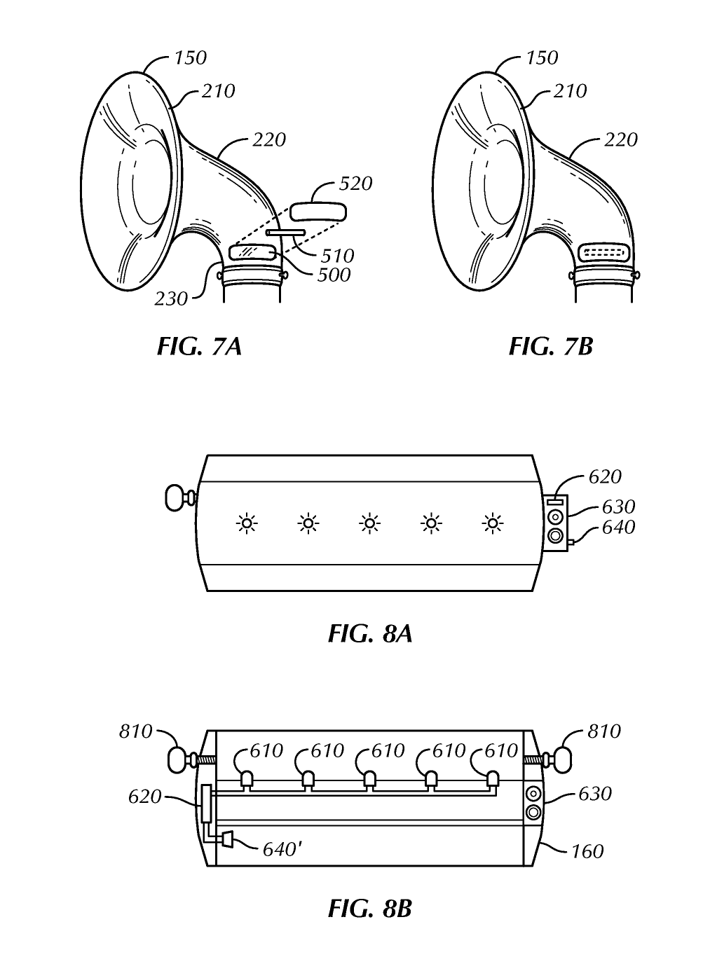

FIG. 7 illustrates an embodiment where the source of the transmitted light is created by a chemical light (510) [commonly referred to as a chemlight or glowstick] or other similar chemical reaction type light source which is placed adjacent to a polished portion (500) of the bell allowing light to be transmitted into the material. To conserve the light being generated and preserve the effect, an opaque cover (520) can cover the light causing the light to only emit to the bell material. By making at least the side of the opaque cover (520) in contact with the bell of a reflective nature, any light emitted away from the bell would be reflected back into the bell material causing a greater intensity.

FIG. 8A illustrates an embodiment where the source of the transmitted light is created by an electronic device. Such a device can be formed into or attached to the bell (150). It comprises a plurality of electronic light sources (610), a power source (630), a switch (640) for controlling the state of the device, and an electronics circuit (620) for controlling the sequencing. An alternative input (640′) such as a microphone, or transducer could be used to sense the instruments sound or vibration and respond appropriately.

FIG. 8B illustrates an embodiment wherein the electronic device comprises an adapter collar (160) for use with a translucent bell (150) of a musical instrument.

The above discussion is meant to be illustrative of the principles and various embodiments of the present invention. Numerous variations and modifications will become apparent to those skilled in the art once the above disclosure is fully appreciated. It is intended that the following claims be interpreted to embrace all such variations and modifications.

What is claimed is:

1. A musical instrument comprising:
a mouthpiece;
a main body with a plurality of tubular pathways; and
a bell, wherein the bell comprises a different material than the body of the instrument.

2. A musical instrument, as described in claim 1 wherein the bell material is translucent.

3. A musical instrument, as described in claim 2 wherein the translucent material is clear in color such that it is substantially transparent.

4. A musical instrument, as described in claim 2 wherein the translucent material is tinted with a color.

5. A musical instrument, as described in claim 2 wherein the translucent material is tinted with a plurality of colors.

6. A musical instrument, as described in claim 1 further comprises a plurality of light emitting elements.

7. A musical instrument, as described in claim 6 wherein the instrument further comprises electronics to control the sequential transition between an on and off state of more or more of the light emitting elements.

8. A musical instrument, as described in claim 6 wherein the instrument further comprises an input to control the sequential transition of the light emitting elements in response to the sound produced by the instrument.

9. A musical instrument, as described in claim 6 wherein the instrument further comprises an input to control the sequential transition of the light emitting elements in response to the vibrations produced by the instrument.

10. A musical instrument, as described in claim 7 wherein the input controls the color of the light emitting elements.

11. A musical instrument, as described in claim 6 wherein the light emitting elements transmit light throughout the bell.

12. A musical instrument, as described in claim 6 wherein the light emitting elements are electronic in nature.

13. A musical instrument, as described in claim 6 wherein the light emitting elements are chemical in nature.

14. A musical instrument, as described in claim 1 wherein the bell is attached to the main body with a collar; with one end adapted to connect securely to the main body of the instrument; and the other end adapted to connect securely to the bell of the instrument.

15. A musical instrument, as described in claim 14 wherein the collar further comprises a plurality of light emitting elements.

16. A musical instrument, as described in claim 15 wherein the collar transmits light from the light emitting elements throughout the bell.

17. A musical instrument, as described in claim 15 wherein the collar further comprises electronics to control the sequential transition between an on and off state of more or more of the light emitting elements.

18. A musical instrument, as described in claim 15 wherein the collar further comprises an input to control the sequential transition of the light emitting elements in response to the sound produced by the instrument.

19. A musical instrument, as described in claim 15 wherein the collar further comprises an input to control the sequential transition and color of the light emitting elements in response to the vibrations produced by the instrument.

20. A musical instrument, as described in claim 1 wherein the bell of the instrument is covered with a bell sock comprising a semi-transparent mesh material with optional printing or graphics.
